(19) United States
(12) Patent Application Publication
(10) Pub. No.: US 2002/0098036 A1
(43) Pub. Date: Jul. 25, 2002

(54) Screwing device and method for locking a control rod drive housing tube nut of a nuclear power station

(76) Inventors: Reinhardt Strobel, Nurnberg (DE); Friedrich Leibold, Happurg (DE)

Correspondence Address: LERNER AND GREENBERG, P.A., Post Office Box 2480, Hollywood, FL, 33022-2480, US

(21) Appl. No.: 10/073,552

(22) Filed: Feb. 11, 2002

Related U.S. Application Data
(63) Continuation of application No. PCT/EP00/07481, filed on Aug. 2, 2000.

(30) Foreign Application Priority Data
Aug. 11, 1999 (DE) 199 37 955.6

(51) Int. Cl. F16B 1/00; F16D 1/00; B25G 3/02

(52) U.S. Cl. 403/362

(57) ABSTRACT

A screwing device is described that contains a drive housing tube nut to be screwed onto a control rod drive housing tube of a nuclear power station. The drive housing tube nut has an axis of rotation. A locking pin is disposed into the drive housing tube nut. The locking pin is disposed inclined radially to the axis of rotation at an axial inclination angle with respect to the axis of rotation of the drive housing tube nut. The locking pin is further oriented such that one component of orientation of the locking pin points in a tangential direction.

### CROSS-REFERENCE TO RELATED APPLICATION

This application is a continuation of copending International Application No. PCT/EP00/07481, filed Aug. 2, 2000, which designated the United States.

### BACKGROUND OF THE INVENTION

1. Field of the Invention

The invention relates to a screwing device with a drive housing tube nut which is capable of being screwed onto a control rod drive housing tube of a nuclear power station, and with a locking pin capable of being introduced into the drive housing tube nut.

The invention relates, furthermore, to a method for locking a drive housing tube nut screwed onto a control rod drive housing tube of a nuclear power station, the drive housing tube nut being locked by a locking pin projecting out of it.

Published, Non-Prosecuted German Patent Application DE 36 11 25 251 A1 discloses a clamping nut which is capable of being screwed onto the thread of a rotatably mounted shaft and which can be secured by a securing screw inclined with respect to the axis of rotation.

In a boiling water nuclear reactor, the control rods are introduced into the interior of the reactor pressure vessel through nipples that are mounted on the underside of the reactor pressure vessel. Welded into each of the nipples is a control rod drive housing tube, into which a control rod with a control rod guide tube is inserted in each case. The nipples and the control rod drive housing tubes are oriented vertically.

For reasons of redundant safety, the control rod drive housing tubes are secured in each case by a drive housing tube nut. The drive housing tube nut surrounds the control rod drive housing tube and is screwed there onto an external thread. The drive housing tube nut rests with its underside on the top edge of the respective nipple of the reactor pressure vessel, thus preventing the situation where, assuming a failure or fracture of the respective welding-in seam, the control rod drive housing tube in question, driven by the pressure prevailing in the interior of the reactor pressure vessel or by its own weight, leaves its installation position and is pressed out of the nipple.

The drive housing tube nut can be secured against twisting and loosening by a locking pin or cylindrical pin. For this purpose, the locking pin was pushed through a bore, running parallel to the control rod drive housing tube, in the drive housing tube nut, until a part of the locking pin which projects beyond the bore latches into a blind hole on the nipple.

The function of securing the drive housing tube nut by a locking pin of this type may diminish, particularly after the reactor has been in operation for many years. To be precise, due to the vibrations of the reactor pressure vessel while it is in operation, due to slight assembly errors which possibly exist or due to expansions occurring during the operation of the reactor as a result of temperature differences, the locking pin could be knocked out or even released, with the result that the drive housing tube nut would also after some time become moveable and therefore releasable.

### SUMMARY OF THE INVENTION

It is accordingly an object of the invention to provide a screwing device and a method for locking a control rod drive housing tube nut of a nuclear power station that overcome the above-mentioned disadvantages of the prior art devices and methods of this general type, in which a drive housing tube nut for a control rod drive housing tube can be secured more reliably than hitherto, so that, overall, a longer reliable operating time of the drive housing tube nut is achieved.

With the foregoing and other objects in view there is provided, in accordance with the invention, a screwing device. The device contains a drive housing tube nut to be screwed onto a control rod drive housing tube of a nuclear power station. The drive housing tube nut has an axis of rotation. A locking pin is disposed into the drive housing tube nut. The locking pin is disposed inclined radially to the axis of rotation at an axial inclination angle with respect to the axis of rotation of the drive housing tube nut. The locking pin is further oriented such that one component of orientation of the locking pin points in a tangential direction.

In a screwing device of the type initially mentioned, the object relating to the device is achieved, according to the invention, in that, in the introduced state, the locking pin is disposed inclined at an axial inclination angle with respect to the axis of rotation of the drive housing tube nut.

Calculations and tests have shown that, in a screwing device of this type, the drive housing tube nut is secured particularly reliably against release and movements. Such a screwing device is also capable of being retrofitted in a simple way.

A particular advantage of the screwing device according to the invention, as compared with other solutions that may be envisaged, not based on a locking pin, is that the outer contour of the drive housing tube nut is not changed by the locking pins to be introduced. This is particularly important in a nuclear power station, where a change in the outer contour on the drive housing tube nut would lead to a change in the flow cross section for the reactor cooling water. An adverse influence on the inflow behavior which would result from the possible installation of additional components on the drive housing tube nut, for example screws, clamping pieces or similar components, with a resulting cross-sectional narrowing, is consequently ruled out.

Preferably, the axial inclination angle has a value of between 5° and 20°, preferably of 10°.

According to a preferred embodiment, the locking pin for locking the drive housing tube nut is capable of being mounted in such a way that it projects out of the inner cylindrical surface of the drive housing tube nut, in particular out of the internal thread of the drive housing tube nut.

According to another preferred embodiment, in the introduced state, the locking pin is oriented in such a way that one component of its orientation points in a tangential direction.

In this case, therefore, the locking pin is disposed askew with respect to the axis of rotation of the drive housing tube nut. A locking pin oriented in this way is particularly fatigue-resistant, even under changing thermal influences and expansions resulting from these and in the case of pronounced vibrations.

Preferably, the amount of the tangential inclination angle in the orientation has a value of between 70° and 85°, preferably of 75°, the tangential inclination angle being measured in a plane perpendicular to the axis of rotation and with respect to a tangent to the drive housing tube nut.

According to a particularly preferred embodiment, the tangential direction of orientation of the locking pin is opposite to a rotational movement releasing the drive housing tube nut.

For example, in the event of a vibrating rotational movement, the locking pin oriented in this way is loaded primarily axially and, to a lesser extent than in the case of a locking pin disposed parallel to the axis of rotation of the drive housing tube nut, perpendicularly to its axis. Such a locking pin is therefore knocked to a particularly small extent out of a bore receiving it and is subjected to particularly low load and wear.

Preferably, the locking pin is configured elastically in its axial and/or radial direction. For example, the locking pin is a dowel pin, a sleeve, a cotter pin, a clamping sleeve or a slotted sleeve.

In particular, there are at least three locking pins that are disposed equidistantly along a circumferential line around the drive housing tube nut.

In regards to the method of the type initially mentioned, the object relating to the method is achieved, according to the invention, in that a bore or groove is made through the screwed-on drive housing tube nut into the control rod drive housing tube and is inclined at an axial inclination angle with respect to the axis of rotation of the drive housing tube nut, and the opening being oriented such that one component of orientation of the opening points in a tangential direction. A locking pin is introduced into the bore or into the groove.

The method is carried out, in particular, such that, in this case, a screwing device according to the invention is produced. The advantages mentioned with regard to the screwing device apply in a similar way to the method according to the invention.

The drive housing tube nut can be prefabricated with a bore for the locking pin even before being screwed onto the control rod drive housing tube. Then, with a drive housing tube nut screwed on, a blind hole necessary for locking in the control rod drive housing tube can be made through the prefabricated bore in the control rod drive housing tube.

According to a preferred embodiment of the method, the axial inclination angle has a value of between 5° and 20°, preferably of 10°.

According to a further preferred embodiment of the method, the bore or groove starts from one end face of the drive housing tube nut. This affords particularly simple access to the drive housing tube nut for the purpose of making the bore or groove.

According to another preferred embodiment, the bore or groove passes through the inner cylindrical surface of the drive housing tube nut, in particular the internal thread of the drive housing tube nut.

Preferably, the bore or groove is oriented in such a way that one component of its orientation points in a tangential direction.

In particular, the amount of the tangential inclination angle in the orientation has a value of between 70° and 85°, preferably of 75°, the tangential inclination angle being measured in a plane perpendicular to the axis of rotation and with respect to a tangent to the drive housing tube nut.

Particularly preferably, the tangential direction of orientation of the bore or groove is opposite to a rotational movement releasing the drive housing tube nut.

Other features which are considered as characteristic for the invention are set forth in the appended claims.

Although the invention is illustrated and described herein as embodied in a screwing device and a method for locking a control rod drive housing tube nut of a nuclear power station, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, longitudinal sectional view of an exemplary embodiment of a screwing device according to the invention in a mounted state on a control rod drive housing tube;

FIG. 2 is an illustration diagrammatically showing an orientation of a locking pin of the screwing device shown in FIG. 1; and

FIG. 3 is an illustration showing the orientation of the locking pin shown in FIG. 1 in a viewing direction parallel to an axis of the control rod drive housing tube.

### DESCRIPTION OF THE PREFERRED EMBODIMENTS

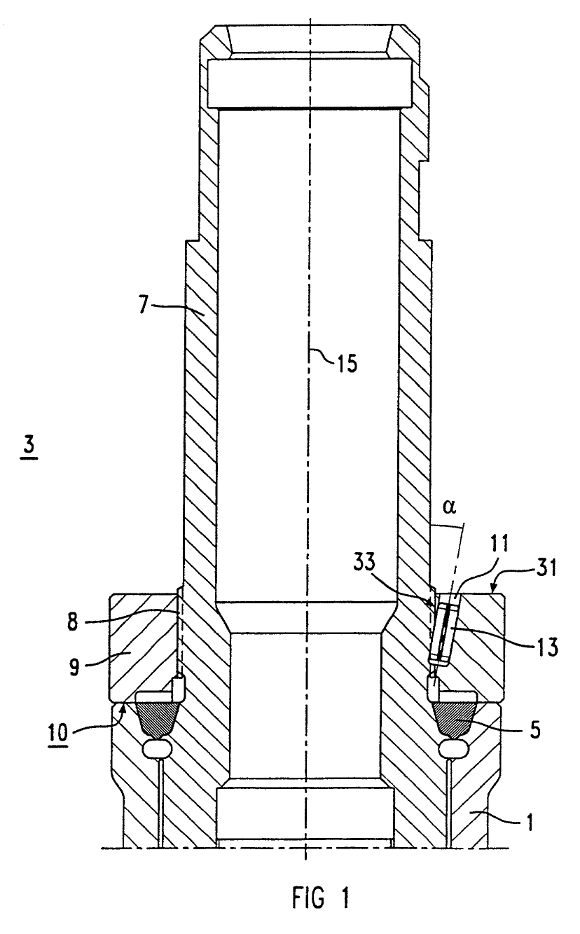

In all the figures of the drawing, sub-features and integral parts that correspond to one another bear the same reference symbol in each case. Referring now to the figures of the drawing in detail and first, particularly, to FIG. 1 thereof, there is shown a circular nipple 1 which projects into an interior 3 of a reactor pressure vessel, otherwise not illustrated, of a boiling water reactor. A control rod drive housing tube 7 is welded into the nipple 1 via a welded joint 5. A non-illustrated control rod can be introduced through the control rod drive housing tube 7 by a control rod guide tube.

In the event of a postulated break of the welded joint 5, the control rod drive housing tube 7 would be pressed downward out of the nipple 1 on the reactor pressure vessel as a result of the overpressure prevailing in the interior 3. In order to prevent this, a drive housing tube nut 9 is screwed on the control rod drive housing tube 7 via an external thread 8 formed there. The drive housing tube nut 9 rests, on its lower end face, on a top side 10 of the nipple 1 and is braced relative to the latter. It has a diameter of approximately 210 mm.

The drive housing tube nut 9 has hitherto been secured by a cylindrical pin 13 that has been guided through a bore parallel to the control rod drive housing tube 7 and latched in the nipple 1.

To improve mechanical resistance, according to the invention a bore 11 having the cylindrical pin or locking pin 13 is disposed in the drive housing tube nut 9 in such a way that the bore 11 and the locking pin 13 are inclined at an axial inclination angle α with respect to an axis of rotation 15 of the drive housing tube nut 9.

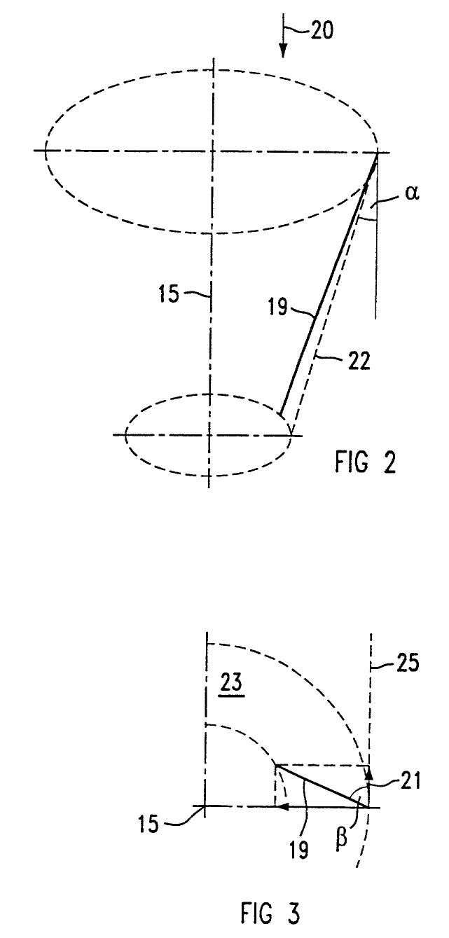

Moreover, the bore 11 and, in the introduced state, additionally the locking pin 13 are also inclined with respect to a plane which is spanned by the axis of rotation 15 and by a radius (the drawing plane in the example depicted). A resulting orientation 19 of the locking pin 13 with respect to the axis of rotation 15 is explained in more detail diagrammatically in FIGS. 2 and 3. FIG. 3 shows, in this case, the orientation 19 (of FIG. 2) from a viewing direction parallel to the axis of rotation 15.

In FIG. 2, 22 designates an orientation of the locking pin 13, such as would occur if the locking pin 13 were inclined solely with respect to the axis of rotation 15 of the drive housing tube nut 9 (inclination angle α). In the orientation designated by 19, the locking pin 13 is additionally oriented in such a way that one component of the orientation 19 points in a tangential direction 21. To describe the tangential component of the orientation 19, a tangential inclination angle β is illustrated. It is measured in a plane 23 (FIG. 3) perpendicular to the axis of rotation 15 and, in the plane 23, with respect to an imaginary tangent 25 to the drive housing tube nut 9.

In the example depicted, the axial inclination angle α amounts to 10° and the tangential inclination angle β likewise to 10°.

The tangential direction 21 of the orientation 19 of the locking pins 13 is opposite to a rotational movement releasing the drive housing tube nut 9. Looking at FIG. 3, therefore, in the example depicted, the drive housing tube nut 9 is tightened by a clockwise rotational movement and released by a counterclockwise rotational movement.

To introduce the locking pin 13, the drive housing tube nut 9 is screwed onto the control rod drive housing tube 7. In the position to be locked of the drive housing tube nut 9, the bore 11 is made, starting from one end face 31 (FIG. 1) of the drive housing tube nut 9, through the drive housing tube nut 9 by a remote-controlled eroding tool or a drill, so as to pass through an inner cylindrical surface 33 of the drive housing tube nut 9 into the control rod drive housing tube 7. The intrusion of the bores 11 into the drive housing tube 7 does not present any problem, since the bores 11 are not located, there, in the pressure-carrying region. Overall, three bores 11 are made at an equal angular interval (of approximately 120°) along a circumferential line around the drive housing tube nut 9.

Subsequently, three locking pins 13 are inserted into the bores 11 until they latch in the control rod drive housing tube 7. The locking pins 13 are secured in this position against creeping out by calking or a local deformation of the drive housing tube nut 9 in the region of the bore 11.

The locking pins 13 are configured elastically in such a way that differential expansions resulting from the temperature difference between the control rod drive housing tube 7 and the drive housing tube nut 9 are compensated for, without the possibility of play occurring between the locking pins 13 and the drive housing tube nut 9 or between the drive housing tube nut 9 and the control rod drive housing tube 7. Moreover, even a loosening of the locking pins 13 caused by the on-flow of the cooling water in the reactor pressure vessel or by expansions as a result of the temperature differences is as far as possible prevented by the inclined configuration according to the invention of the locking pins 13.

The locking pins 13 having a diameter of 8 to 12 mm are configured as elastic clamping sleeves. They may have a length of approximately 30 mm.

We claim:

1. A screwing device, comprising:
a drive housing tube nut to be screwed onto a control rod drive housing tube of a nuclear power station, said drive housing tube nut having an axis of rotation; and
a locking pin disposed into said drive housing tube nut, said locking pin disposed inclined radially to said axis of rotation at an axial inclination angle with respect to said axis of rotation of said drive housing tube nut, said locking pin further oriented such that one component of orientation of said locking pin points in a tangential direction.

2. The screwing device according to claim 1, wherein said axial inclination angle has a value of between 5° and 20°.

3. The screwing device according to claim 1, wherein:
said drive housing tube nut has an inner cylindrical surface; and
said locking pin for locking said drive housing tube nut can be applied such that said locking pin projects out from said inner cylindrical surface of said drive housing tube nut.

4. The screwing device according to claim 1, wherein an amount of a tangential inclination angle of said orientation has a value of between 70° and 85°, said tangential inclination angle being measured in a plane perpendicular to said axis of rotation and with respect to a tangent to said drive housing tube nut.

5. The screwing device according to claim 1, wherein said tangential direction of said orientation of said locking pin is opposite to a rotational movement releasing said drive housing tube nut.

6. The screwing device according to claim 1, wherein said locking pin is selected from the group consisting of dowel pins, clamping sleeves, and slotted sleeves.

7. The screwing device according to claim 1, wherein said locking pin is one of at least three locking pins disposed equidistantly along a circumferential line around said drive housing tube nut.

8. The screwing device according to claim 1, wherein said axial inclination angle has a value of 10°.

9. The screwing device according to claim 1, wherein:
said drive housing tube nut has an internal thread; and
said locking pin for locking said drive housing tube nut can be applied such that said locking pin projects out from said internal thread of said drive housing tube nut.

10. The screwing device according to claim 4, wherein said tangential inclination angle is 75°.

11. A method for locking a drive housing tube nut screwed onto a control rod drive housing tube of a nuclear power station, which comprises the steps of:
forming an opening selected from the group consisting of bores and grooves through the drive housing tube nut into the control rod drive housing tube, the opening being inclined radially to an axis of rotation at an axial inclination angle with respect to the axis of rotation of the drive housing tube nut, and the opening being oriented such that one component of orientation of the opening points in a tangential direction; and
introducing a locking pin into the opening for locking in place the drive housing tube nut.

12. The method according to claim 11, which comprises setting a value of the axial inclination angle to be between 5° and 20°.

13. The method according to claim 11, which comprises starting the opening from one end face of the drive housing tube nut.

14. The method according to claim 11, which comprises making the opening to pass through an inner cylindrical surface of the drive housing tube nut.

15. The method according to claim 11, which comprises setting an amount of an tangential inclination angle in the orientation to a value of between 70° and 85°, the tangential inclination angle being measured in a plane perpendicular to the axis of rotation and with respect to a tangent to the drive housing tube nut.

16. The method according to claim 11, which comprises setting the tangential direction of the orientation of the opening to be opposite to a rotational movement releasing the drive housing tube nut.

17. The method according to claim 11, which comprises setting a value of the axial inclination angle to be 10°.

18. The method according to claim 11, which comprises making the opening to pass through an internal thread of the drive housing tube nut.

19. The method according to claim 15, which comprises setting the value of the tangential inclination angle to be 75°.
